(19) United States
(12) Patent Application Publication
(10) Pub. No.: US 2007/0133018 A1
(43) Pub. Date: Jun. 14, 2007

(54) Graphics color proofing system

(76) Inventors: Barry Bridwell, Georgetown, IN (US); Wayne Hogarth, Fayetteville, GA (US)

Correspondence Address: INTERNATIONAL PAPER COMPANY, 6285 TRI-RIDGE BOULEVARD, LOVELAND, OH, 45140, US

(21) Appl. No.: 11/296,160

(22) Filed: Dec. 7, 2005

(51) Int. Cl. G06F 15/00

(52) U.S. Cl. 358/1.9

(57) ABSTRACT

A process for the development of a proof of an image without press setup and trial runs and including visually useful multiple acceptable variations in the color scheme of multiple images of an image outputted from a given printing press, for judging the presence of unacceptable variations, relative to the visually observable proof and its accompanying acceptable color variations.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

This invention relates to the printing of digital images onto a printable surface employing a printing press. More particularly, it relates to the proofing of a digital image preparatory to printing of the image.

### BACKGROUND OF THE INVENTION

Current printing processes are based on half-tone screening. Conventional half-tone is an amplitude modulated process in which continuous shading is simulated by varying the size of equally-spaced printed dots. The resolution of the dots is called the line screen ruling. The dots are oriented at an angle called the screen angle.

In printing, “halftone” refers to a continuous tone image, such as a photograph, that has been converted into a black-and-white image. Halftones are created through a process called dithering, in which the density and pattern of black and white dots are varied to simulate different shades of gray. In conventional printing, halftones are created by photographing an image through a screen. The screen frequency, measured in lines per inch, determines how many dots are used to make each spot of gray. In theory, the higher the screen frequency (the more lines per inch), the more accurate the halftone will be.

Modern desktop publishing systems can create halftones by simulating the conventional photographic process.

Color images usually use four primary colors, cyan, magenta, yellow and black (CMYK) and are printed at different screen angles to minimize the color shifts due to mis-registration during the printing process. The angles are also selected for each color to minimize the occurrence of interference patterns call Moire'. Typical screen angles are C=15, M=75, Y=0, and K=45.

Proofing is the process of generating a sample print, which represents the output expected from a given printing press. Operational parameters of printing presses are provided by their manufacturers and are well known and readily available in the industry (Specifications for Web Offset Printing (SWOP)). Digital Proofing printers or “proofers” are relatively inexpensive printers that strive to accurately represent the printing press output, color and quality. For cost efficiency and other reasons, in the prior art, the initial digital data is color-corrected to fit the operational parameters of the proofer in an attempt to get the proofer to print out an acceptable color replica of the initial digital image. Theoretically, the setup of the proofer mimics the setup of the selected press. The result however is a first set of data useful on the proofer (ie. the color-corrected initial digital data) and a second set of data useful on the printer (ie., the color-corrected initial digital data used on the proofer plus the modifications made in the halftone process).

Commonly in the prior art, a single proof is outputted from the proofer which has been selected and setup to mimic the chosen printing press, and using the color corrected data. This proof serves as the standard by which the printing personnel and/or the originator of the initial digital data judge whether the color corrected data is satisfactory for use with the selected printing press. That is, this proof is visually inspected by the press operator or others vis-à-vis a visual image of the initial digital data to determine whether the color corrections are proper for use with the selected printer. If not, the half-tone procedure and the proof printing steps and the image/proof comparison are again carried out either once or as many times as needed to produce a proof which does not vary unacceptably from the initial image.

However, when the press is set up using the color-corrected proofer data set, as modified by the halftone process, and printing commences, the printed images may or may not be satisfactorily like the initial digital image, but this can not be known for certain until the press outputs printed images. If the printed images are not acceptable correction to the printing press are made and the printing process recommenced.

In modern printing, when it is often desired to print multiple copies of a given image, such as labels on containers, and the like, not uncommonly, the printing medium used is paper in web form. Printing presses are operated at relatively high speeds so that multiple printed images printed one after another on the print medium visually readily reveal variations in the color combination being printed.

Variations in color when printing multiple copies of a digital image are normal, almost universal. Assuming that the preset operating parameters of the selected printer for a selected digital image are in fact proper, variations yet may be created in part by variations in the printer itself, and/or in part by variations in the physical properties of the medium onto which the images are printed. In some instances, the variations are the result of a combination of printer operating error and print medium quality. Therefore it is well recognized in the art that some degree of color variation will occur in the printing of a given digital image onto a print medium. The need therefore exists to determine what variations or degrees of variation are acceptable in the printing of a given digital image and to make such information readily available to press operators and/or other printing personnel.

In the prior art, once the press operator notes what is perceived to be an unacceptable variation in the colors of the printed images on the print medium, he is forced to halt the printing operation and, hopefully, locate and cure the variation. If he is unable to do so, he may repeat the original image/proof procedure. Such repetitions of the image proof procedure are time-consuming and costly. More frequently, however, the printer operator will judge that the source of the variation lies within the print medium, so he contacts the supplier of the print medium and demands new print medium to replace that print medium which he deems to be unacceptable. The supplier of the print medium is faced with a dilemma. On the one hand, he can not go into the print shop and conduct tests to determine whether the variation noted by the printer operator is within normal tolerances, was caused by faulty image/proofing, was caused by a malfunction in the press, etc. This places the supplier in the most unwelcome situation of refusing to replace the print medium and likely losing the customer, or replacing the print medium, at no cost to the print shop, all the while not knowing whether the replacement print medium will perform any differently than the originally supplied print medium if the printing press continues to be operated using unchanged data or operating parameters.

In addition to the factors noted hereinabove, it is not uncommon that the press operator merely misjudges the acceptability of perceived variation in the color between successive ones of the images being printed onto the print medium.

### BRIEF SUMMARY OF THE INVENTION

The present invention provides a process for the development of a Foolproof proof of an initial digital image without press setup and trial runs and further providing visually useful multiple graduated acceptable variations in the color scheme of an initial digital image being outputted from a press, for judging the presence of unacceptable variations, relative to the visually observable proof and its accompanying acceptable color variations.

### BRIEF DESCRIPIION OF THE FIGURES

FIG. 1 is a schematic flow sheet depicting various steps of one embodiment of the process of the present invention;

FIG. 2 is a printout of an initial digital image desired to be reproduced;

FIG. 3 is a Foolproof of the initial digital image of FIG. 2 developed employing the process of the present invention;

FIG. 4 is a graphic representation of a typical Density Curve;

FIG. 5 is a typical halftone screen depicting a portion of the initial digital image depicted in FIG. 2; and,

FIG. 6 is a typical layout sheet used in developing the Foolproof of FIG. 3.

### DETAILED DESCRIPTION OF THE INVENTION

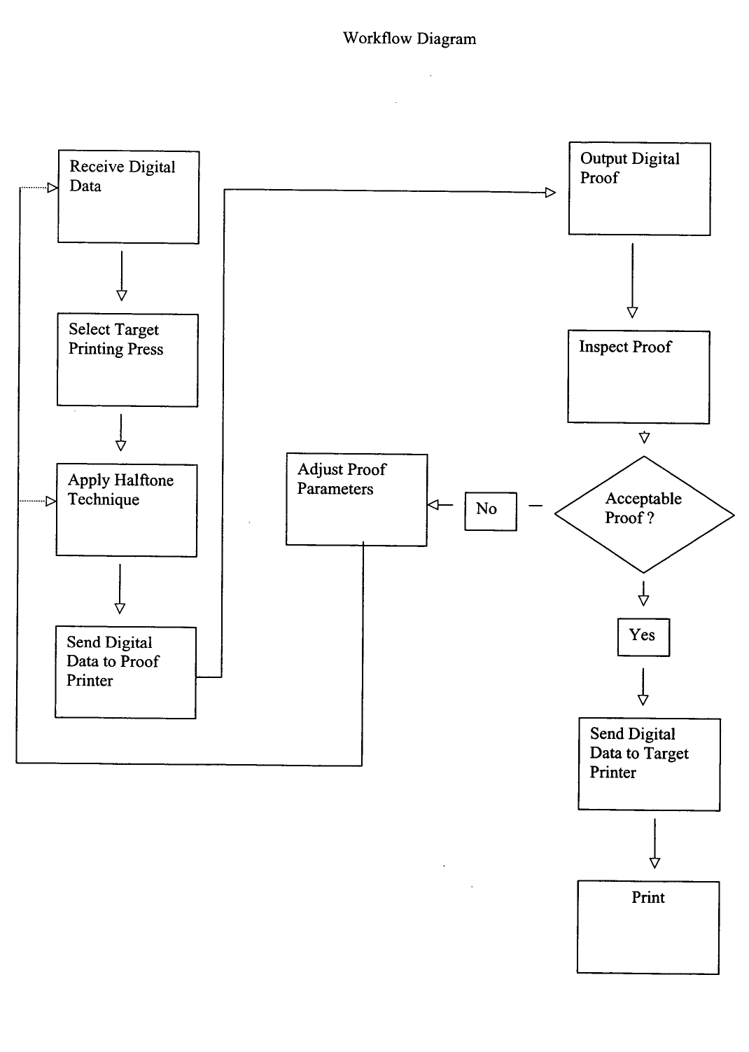

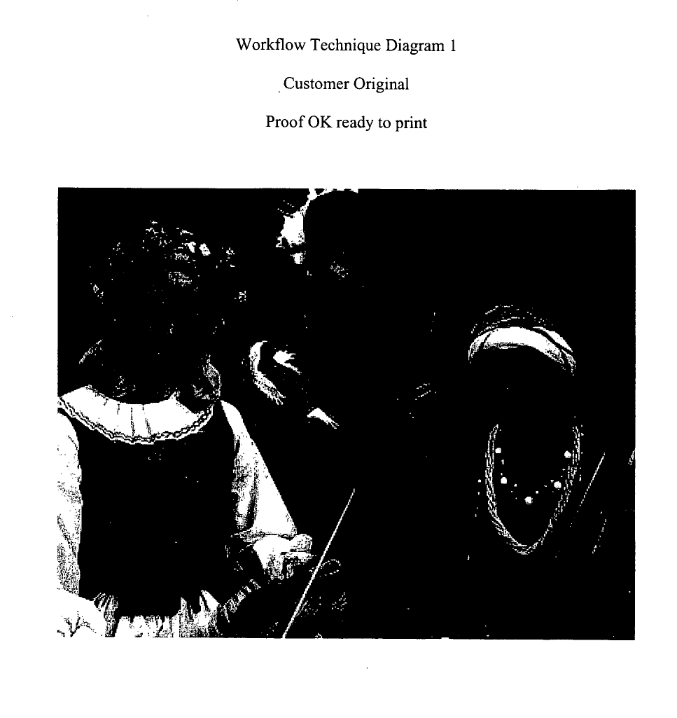

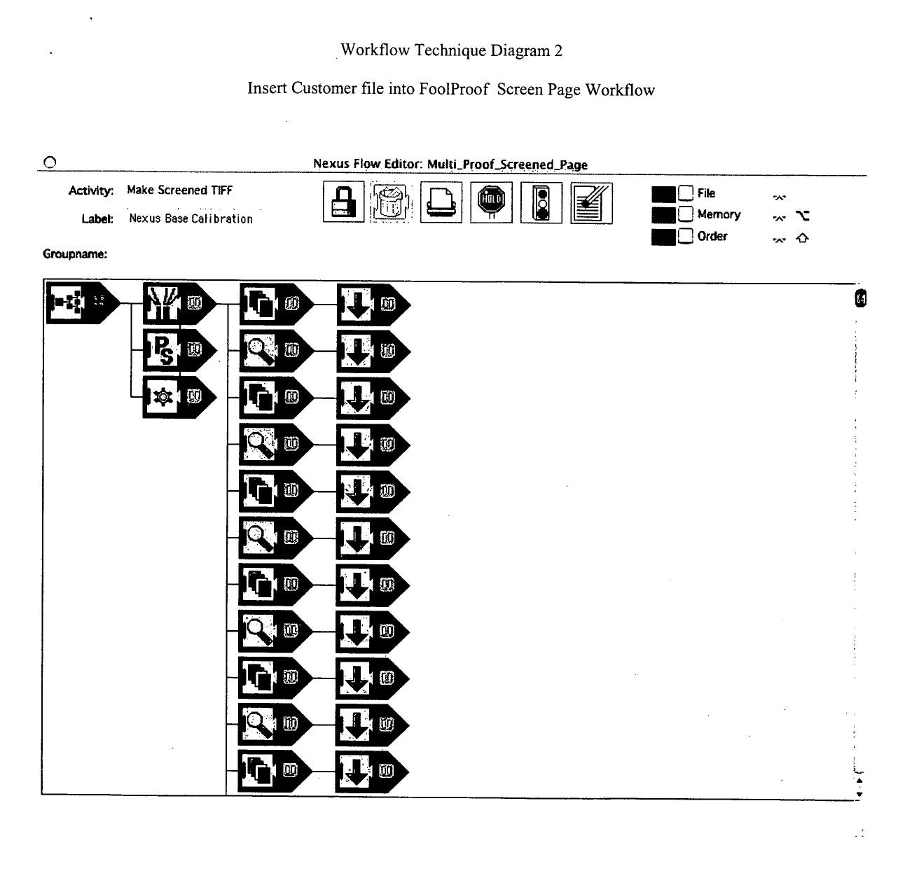

FIG. 1 depicts the steps of a preferred embodiment of the process 12 of the present invention. The first step 14 as comprised the receipt by a proofer (press operator) of an initial digital image 32 (FIG. 2), comprising a set of digital data which is representative of the original image sought to be reproduced employing a printing press.

A target printing press is selected 16, offset, litho, flexo, etc., to be used to print out reproductions of the original image.

A halftone technique is applied 18 to the initial digital data, such technique generating multiple color variations of each of the primary colors of the original image based upon known Density Curves for each color to develop a digital data set for each of the variations, the variations being within the known acceptable range of color variations attainable by the selected press.

A proofer 21 is chosen and is setup to mimic the operating parameters of the selected press.

The multiple data sets, one for the original image and one for each of the calculated color variations are fed 20 to the proofer, from which a digital proof 21 is outputted. This proof is visually inspected 22. If the proof is not approved as being representative of acceptable variations in the color of images output from the press, the data sets are adjusted 24 as needed, a further halftone technique 18 is applied, the modified data sets are fed to the proofer 20 and a second proof is outputted from the proofer.

If the proof is approved 26 in its first form as being representative of acceptable variations in the color of images output from the press, the data sets from the proofer are fed to the target press 28 and printing 30 commences.

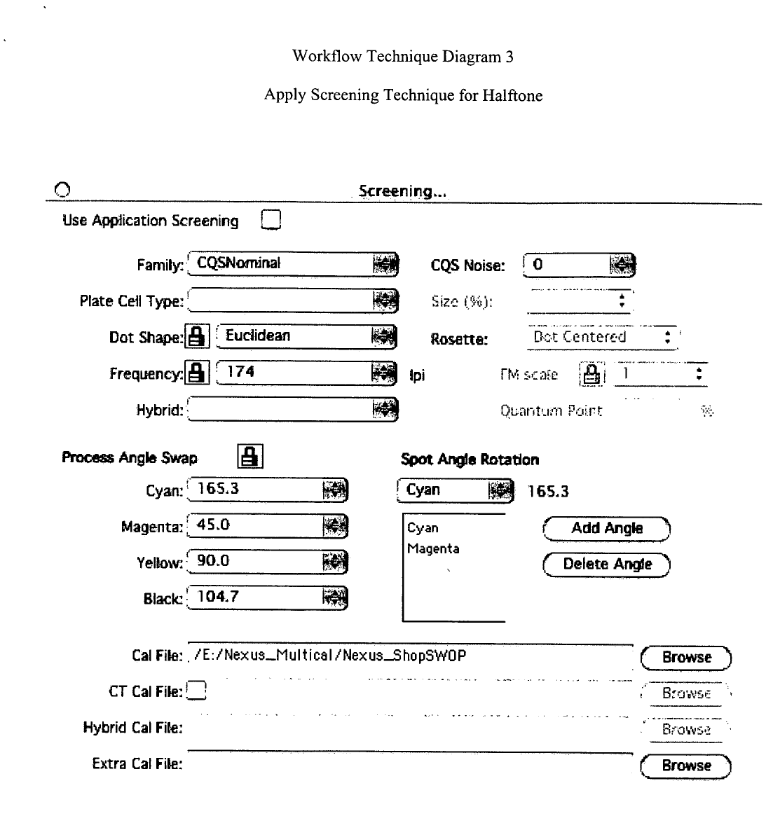

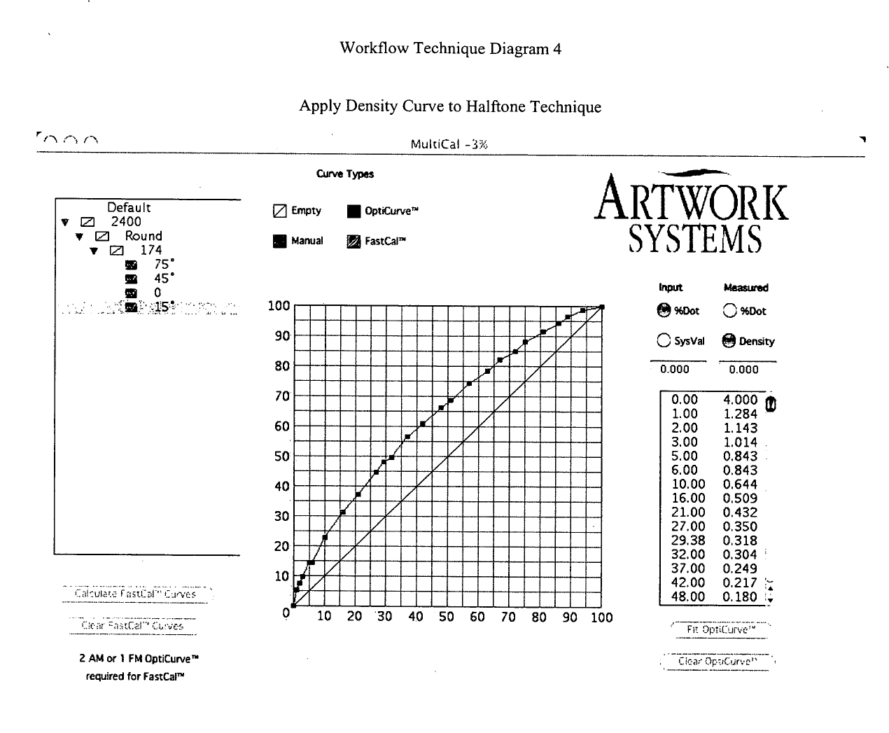

In accordance with one aspect of the present invention, as seen in FIG. 3, the outputted proof is in the form of an image produced from the initial digital data printed centrally of a page 32. A first set 34 of eight visual images of prints employing the variations (36-50), varying in either descending or ascending change in color intensity, aligned in a vertical row along one side 35 of the page and a second set 55 of eight of the variations (52-66), also varying in descending or ascending change in color intensity, aligned in a vertical row along the other and opposite side 68 of the page, thereby providing for ready visual comparison of any one of the images. There further is provided adjacent each dataset, a digitized photographic version of the digital original producale by the press if the associated receipt of CMYK were employed in the press. This arrangement allows the press operator to view, on a single sheet, the original digitized image, 18 different color intensities, etc. of the original image, along with the CMYK formula for each of the 18 different images. With this information the press operator, for example, has the opportunity to compare the original image with permissible color variations thereby providing the pres operator with a standard against which he can judge whether the images outputted by the press vary outside the acceptable variations that are displayed alongside the original image. If the press operator perceives that unacceptable variations are taking place, he can modify the operating parameters of the press, is needed, or even halt the press run if the outputted images from the press show color variation outside the acceptable variations depicted along the sides of the original image.

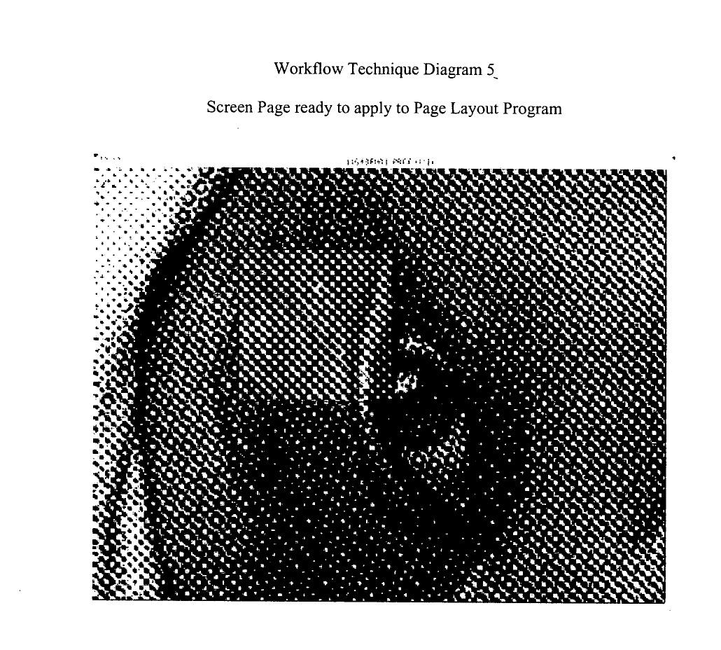

More specifically, in accordance with one aspect of the present invention, there is provided a process in which an initial digital image is created and a printing press for printing the image onto a print medium is selected, for example an offset press. Thereafter, employing a halftone technique, the digital data of the initial digital image is converted into an output which comprises a multiplicity, sixteen, for example, variations of the original image using a “recipe” for each of the primary colors in the screened data. The recipe is a known combination of ink densities and dot gain within the printing press (Specifications for Web Offset Printing (SWOP) established by printer manufacturers or others for given presses) and defines the amount of visual screen tint allowed for each of the multiple variations based on Density Curve 70 (FIG. 4) as is well known in the art. The Curve for each variation may be stored as a lookup table for a subsequently developed proof. Each variation may be a “screen” page (or portion of a page) on a computer and may be printed out employing known computer processing techniques. In a preferred embodiment the output is in the form of a printout of the initial digital image (without color correction) disposed in the center of a page with eight permissible color variations of the initial digitial image aligned in a vertical row along one side margin of the page and a second eight permissible color variations aligned in a vertical row along the opposite side margin of the page. Each variation represents one combination of the four basic colors (CMYK) which is obtainable by the selected press and which is within the margin of variability of the press.

In the halftone process, using commercially available software, the tint of each of the basic colors CMYK in the initial digital image is determined and this tint is corrected up by a positive percentage or down by a negative percentage. The range of the positive and negative corrections is chosen to be within the known SWOP operating parameters of the selected press.

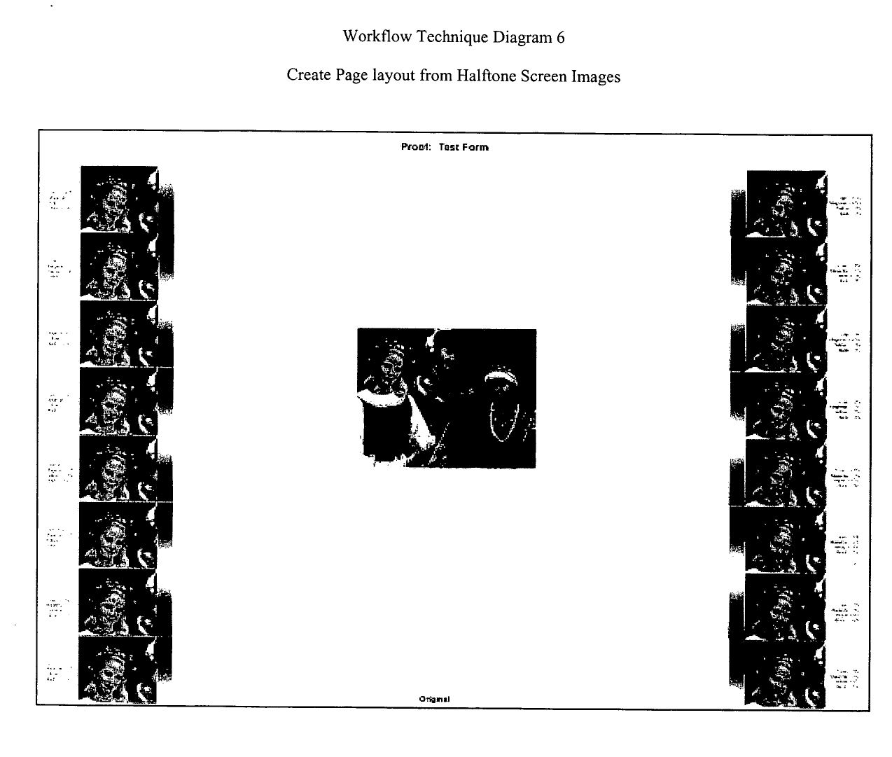

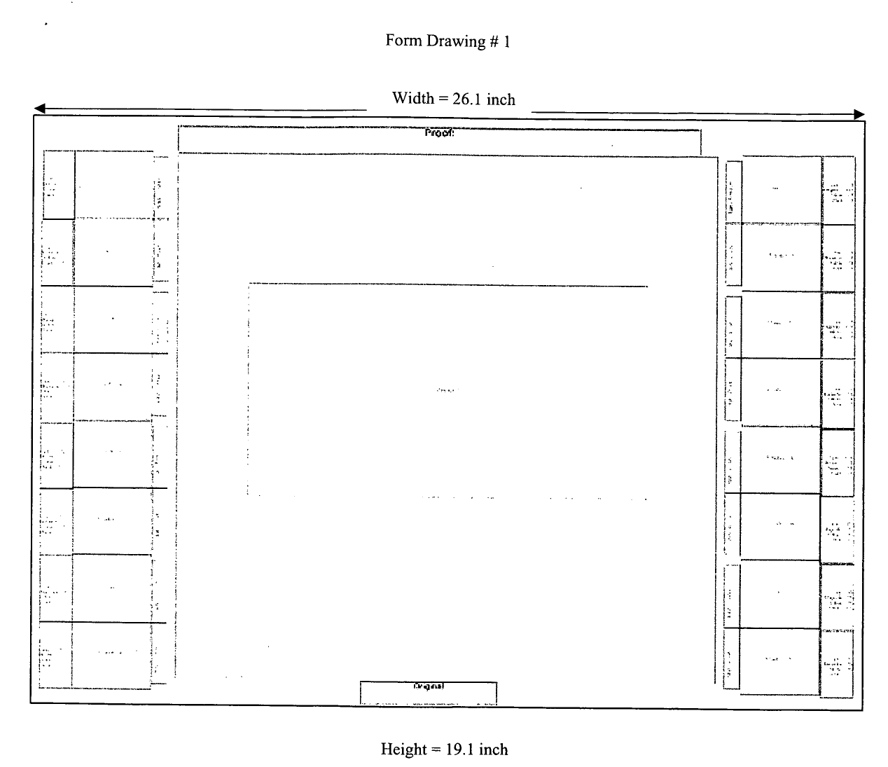

A screen 72, FIG. 5, for example, is thereafter produced for each of the sixteen different tint combinations of these basic colors. These sixteen different images, each with its corrected tints, along with the halftone of the initial digital image are outputted (printed) by the computer as a first and second series of color-corrected visual images whose respective tints vary both darker and lighter than the tints in the initial digital image over an acceptable range. In a preferred embodiment, the image from the initial digital image is disposed centrally of an output (printed) page. A first set of eight of the color-corrected images from the halftone are outputted as a first series of images aligned along a first side of the central image. A second set of eight of the images from the halftone are outputted as a first series of images aligned along a second (opposite) side of the central image.

Within each series of color corrected images, the tint varies from darkest to lightest from top to bottom of the series. As noted, each color-correction represents the tint range of an operating parameter of the selected printer based on the SWOP tables. Therefore, each series of color-corrected images represents the anticipated (and acceptable) variations in the tint of the initial digital images which can be expected to occur when the initial digital image is fed into the press and outputted as multiples of the initial digital image.

Because the digital data developed within the proofer is deemed consistent with the operational parameters of the selected press, a full color (non-halftone) print of the modified initial digital image data can be obtained as an output from the proofer. This proof, in full color and accompanied by the two vertical rows of sixteen color variations of the proof become available for review and approval by the originator of the initial digital data and/or the press operator. This proof is visually examined and evaluated by the originator of the initial digital image and/or the press operator, and/or others to determine the acceptability of the ranges of tint (color) variations which can be expected to occur during the actual press printing operation. If this proof is unsatisfactory, one need only adjust the recipe applied to each of the applicable color combinations to make changes in a subsequently printout from the proofer, a relatively simple and cost-effective means for making certain that the actual printed image is equivalent to the initial digital image, within the known acceptable variances producible in the course of an actual press run.

Thereafter, the same data used for the proofer(color-corrected by the halftone process using the known press operating parameters and approved by all concerned) is fed into the press and printing is commenced. This process provides a foolproof proof for the first operation of the press.

Moreover, during the printing operation, the press operator has before him the known and acceptable color variations which he can visually compare to the color variations in the multiple prints of the initial digital images being outputted by the press, make decisions as to whether the printed image is within the acceptable and anticipated possible color variations of the press, and make corrections, if needed, or stop the overall printing operation, if required. Or, if need be, to change the printing medium.

In accordance with one aspect of the present invention, an initial digital image (see FIG. 1) of a desired to-be-printed product is developed. This initial digital image is subjected to a halftone procedure. Within this halftone procedure, there is selected a portion (window) of the halftone which is deemed to be representative of the extreme variation of color (tint) within the overall halftone.

The tint of each individual dot within the selected area is adjusted both positively and negatively from the known SWOP values of the press which has been selected for printing the product images, to develop a color-corrected set of digital data of the initial digital image suitable as input to the press.

In one embodiment, the workflow of the present invention takes the digital file and outputs it into sixteen different variations of the original data using an established recipe for each of the primary colors on the screened data. The recipe defines the amount of visual screen tints allowed for each of the sixteen variations based on the known Density Curve. The Curves are stored within the workflow as a lookup table for the Proof of the present invention. Each screen page now has a unique look to match a press run variation. These pages are applied to a FoolProof layout form 80 which positions an image 32 of the initial digital data generally centrally of a page with the first series of eight color variations aligned vertically along one side of the page and a second series of eight color variations aligned vertically along the opposite side of the page. This layout form is depicted in Figure. When completed this form becomes the Foolproof and is the data from which it is derived is the data fed to the press.

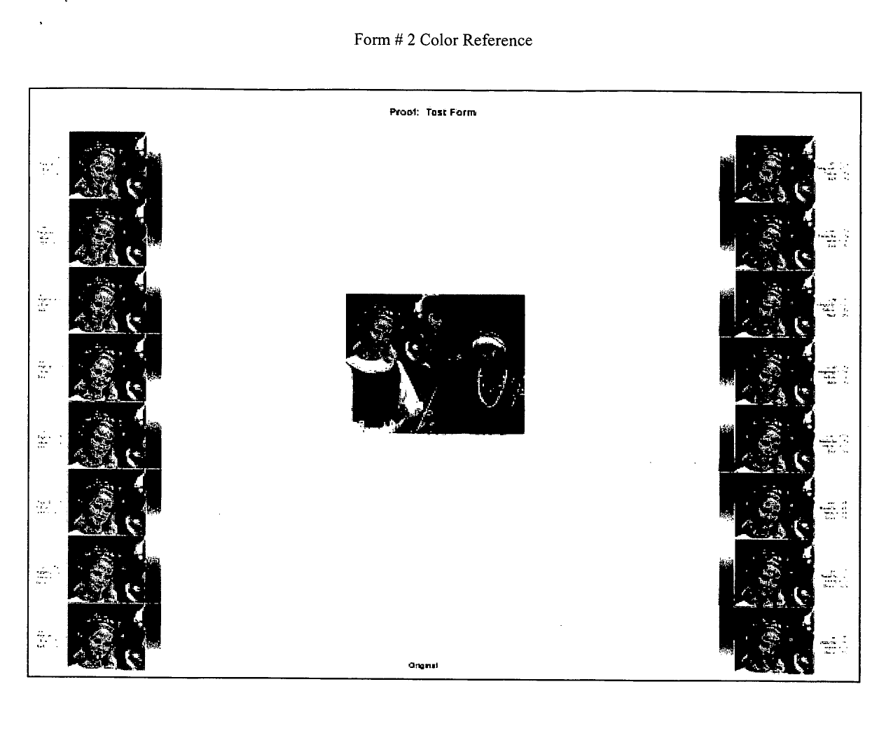

Referring to FIG. 6, a typical proof might include variation No. 1 comprising +36% cyan, 0% magenta, 0% yellow and 0% black. Variation No. 2 could be the same as No. 1, but including −3% cyan. As depicted in FIG. 6, each variation (from 1 through 16) presents a different recipe of CMYK plus an associated digitized image outputted by the selected press for each such variation of CMYK.

Whereas specific descriptive terms and examples are provided in the present specification, it is intended that the invention be limited only set forth in the Claims appended hereto.

What is claimed:

1. A proofing system for a printing process comprising the steps of:
creating a digitized image of an object (print) to be reproduced by a printing process,
selecting a printing press for use in reproducing said digitized image,
converting said initial digitized image to an output which comprises a multiplicity of tint graduations of the original image using a recipe for each of the primary colors in the digitized image.

2. The proofing process of claim 1 wherein said recipe comprises a known combination of ink densities and dot gain within a chosen printing press and defines the amount of visual screen tint allowed for each of the multiple variations based on a known density curve.

3. The printing process of claim 1 wherein said recipe comprises the Specifications for Web Offset Printing for the chosen printing press.

4. The printing process of claim 1 and including the further step of printing said digitized image to provide an output print of said digitized image, printing a plurality of images of said digitized image, each such image being a graduated version of said digitized image, based on the permissible variations in the basic colors employed by the printing press, and displaying said plurality of images alongside said print of said digitized image thereby providing a printing press operator a visual standard for judging the desired functioning of the printing press.

5. A printing process proof comprising a visual digitized version of an image to be printed on a given printing press, and a multiplicity of visual variations of the original image generated using a recipe for each of the primary colors in the digitized image, said multiplicity of visual variations being presented in a format suitable for use by a printing press operator in judging the degree of replication of the digital image by an operating printing press.

6. The proof of claim 5 wherein said variations comprise a series of visual examples of permissible graduated changes in the tint of prints of said digitized image produced by a given printing press.

7. The proof of claim 5 wherein said graduations are established as a function of the specifications for web offset printing associated with a given printer.

8. The proof of claim 5 wherein said print of said digitized image is flanked along at least one side thereof with a plurality of prints of said image, each such print being a graduated representation of said digitized image, such graduations being a function of the specifications for web offset printing for the given printer.
